(19) United States
(12) Patent Application Publication
(10) Pub. No.: US 2008/0074057 A1
(43) Pub. Date: Mar. 27, 2008

(54) Halogen Lamps

(75) Inventors: Dorota Barbara Pawelek, Eindhoven (NL); Gunda Bley, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,757

(22) PCT Filed: Sep. 1, 2005
(86) PCT No.: PCT/IB05/52867

§ 371 Date: Mar. 6, 2007

(30) Foreign Application Priority Data
Sep. 10, 2004 (EP) 04104382.9

(51) Int. Cl. H01K 1/62; H01K 1/22

(52) U.S. Cl. 315/291; 313/579

(57) ABSTRACT

The invention relates to lamps, and particularly to incandescent electric lamps. incandescent electric lamps operating at mains voltage are known for decades and are widespread throughout the world. However, this type of lamp is not power efficient. It is suggested to provide a halogen lamp with a burner surrounded by an outer envelope for an incandescent electric lamp. The appearance of this lamp is identical to known incandescent lamps, but the lamp is more power efficient as it uses the well-known technology of a 12 V halogen lamp.

### FIELD OF INVENTION

The invention relates to lamps, and particularly to incandescent electric lamps. More particularly, it relates to incandescent low voltage lamps which can be used for ambient lighting as well as for accent lighting.

### STATE OF THE ART

Incandescent lamps having an outer envelope which is partly made of glass are known for decades. The lamp houses a burner with a filament inside, whereby the filament generates a diffuse light which can be used for general lighting. These incandescent lamps operate at mains voltage, which may be 120 V or 230 V.

Low voltage lamps are known in the prior art. Low voltage lamps are subjected to a voltage which is low in comparison to the line voltage. In most cases low voltage lamps are operated at 12 V. For operation, a transformer is needed to transform the mains voltage to 12 V. In many cases, the transformer is remote from the halogen burner and may be located in the lamp stand. In other cases the transformer is part of a ballast which is located in the bottom part of the halogen lamp close to the lamp base.

In operation, the burner, which comprises a glass vessel with the filament in its interior, is the hottest part of a halogen lamp. In many cases the burner is surrounded by a reflector in order to have a limited beam width and a high intensity. In this case the burner can easily reach temperatures of more than 250° C. The heat produced by the burner dissipates and warms the reflector as well as the ballast. As the ballast is composed of electronic components, a ballast temperature of more than 125° C. is in most cases unacceptable in order to avoid a decreased life time. For this reason, the maximum wattage of reflector lamps are limited.

Current halogen lamps address this heat problem by using heat shields to protect the ballast. The heat shields are optimized such that infrared (IR) radiation originating from the burner is reflected away from the ballast. For example, flat circular heat shields or plates are used which are placed behind the reflector and in front of the ballast. This avoids that IR radiation impinges on the ballast, and that the heat shield absorbs the IR-radiation. However, a part of the IR-radiation reflected away is directed at the reflector. This in turn leads to an increased absorption of IR-radiation by the reflector which is thermally coupled to the ballast.

EP 1 258 674 A2 discloses a display lamp with a reflector assembly, whereby a heat shield is positioned between the ballast and the reflector assembly. The heat shield is made of a metal to have a material which reflects the IR radiation originating from the burner. The heat shield is optically curved, such that the IR-radiation is reflected away from the halogen lamp, and is not directed at other parts of the halogen lamp such as the reflector assembly.

WO 96/07193 shows a reflector lamp operated at line voltage. The light originates from a burner having an elongated bottom part called the seal. The seal is placed in the opening of a ceramic body placed in the neck of the lamp body. The ceramic body thus surrounds the seal to lower its temperature during operation thereof.

U.S. Pat. No. 4,568,854 shows a tungsten halogen lamp with a burner cemented into a ceramic base. The base has a special design to ensure an enhanced heat dissipation to avoid an excessively high seal temperature.

It is an object of the invention to provide an incandescent lamp and a process for generating light which enable an easy replacement of existing incandescent lamps in standard line voltage electric lamp sockets. This lamp should be usable for ambient lighting as well as for accent lighting.

According to the present invention the above mentioned problem is solved by the features of the independent claims. Further embodiments are described by the features of the sub claims.

According to the invention, the above mentioned problem concerning the halogen lamp is solved by a halogen lamp having an outer envelope for an incandescent electric lamp. This means that the envelope has an upper part being transparent for the light generated by the lamp, whereby the envelope can be used for standard incandescent lamps. Furthermore, the halogen lamp has a bottom part. A low voltage halogen burner is arranged within the upper part of the outer envelope, such that light emitted from the burner transmits through the upper part of the envelope.

The above mentioned problem concerning the process is solved by a process for providing light for ambient lighting, in which in a first step light in the visible region of the electromagnetic spectrum is generated by means of a low voltage halogen burner, and in which in a second step the generated light is sent through a transparent part of the outer envelope of a lamp.

The proposed type of halogen lamp looks like a standard incandescent lamp, but the technology inside bases on the well known low voltage halogen lamp. An incandescent lamp should be understood to be a lamp which can be operated or is operatable at line voltage. The incandescent lamp according to the invention is more power efficient than its antecessors which improves its acceptance due to environmental considerations. The incandescent halogen lamp according to the invention can be used for ambient lighting.

The upper part of the outer envelope is transparent for the light generated by the halogen burner. The upper part has a closed surface with an opening. This opening corresponds to the top surface of the bottom part of the lamp and to the circumference of the lower part of the envelope, such that the bottom part and the upper part can be mechanically connected, e.g. by screwing. It may be moulded from glass, may be blown glass, or may be formed from a synthetic resin by, for example, pressing, casting, or injection-moulding. The upper part may have the form of a blown glass bulb. The bottom part of the outer envelope, which comprises the neck and which is mechanically connected to the lamp cap, may be made of plastic.

The burner may be, for example, an incandescent body in a gas comprising halogen, or a pair of electrodes in an ionizable gas such as, for example, metal halides, rare gas, and possibly mercury.

The incandescent-like halogen lamp according to the invention will be accepted more easily by the customer when a ballast is arranged in the bottom part of the outer envelope. The ballast, for example a solid state electronic ballast, is adapted to transform the mains voltage to a low voltage such as 12 V. In this case the customer can recognize no difference, in appearance and in usage, between a standard incandescent lamp and the incandescent-like halogen lamp according to the invention. In particular, he can use the new type of lamp in the same way as he always did. As the outer dimensions can be chosen to be identical to well-known incandescent lamps, it is possible to replace all standard incandescent lamps, to which the customer is accustomed to, without the need to adapt existing electric installations. For example, existing luminaires adapted to work with incandescent 230 V or 120 V glass bulbs can be equipped with the halogen lamp according to the invention. At the same time the incandescent-like halogen lamp according to the invention has a better power efficiency.

It is favourable if an adapter is arranged between the ballast and the burner. The adapter can have different functions. In the first place it serves to mechanically connect the burner, the ballast, and the outer envelope. In particular, the adapter can be designed to provide a shock-resistant low voltage lamp.

Furthermore, the adapter provides an electric connection between the burner and the power supply. Correspondingly the adapter may have electric contacts on its upper surface facing the burner, and on the bottom surface facing the ballast. This increases the distance between the burner, which is the hottest part of the lamp, and the ballast such that the thermal load of the ballast decreases.

If the wattage of the lamp is about 5 W or higher, a heat shield to protect the ballast as described in the opening part of the specification should be provided. It is particularly desirable that in this case the adapter is the heat shield. For this purpose the adapter can be made of a ceramic, particularly a ceramic having a low thermal conductivity to stop the heat flow from the burner to the ballast. For this purpose, steatite, aluminium oxide, or aluminium nitride can be used.

The electronic circuits for transforming the mains voltage to a low value such as 12 V are potted. The potting material has a thermal conductivity of about 0, 53 W/mK or less.

The geometric shape and the mass of the adapter will be chosen according to the wattage of the lamp. The adapter may have the form of a flat plate which is able to stop the heat flow to the ballast.

The adapter may be spaced apart from the inner surface of the outer envelope. In this case the adapter prevents the ballast from being directly exposed to light from the burner, whereas an exposition by light reflected from the inner surface of the envelope is still possible. This solution, which is particularly favourable for low wattage lamps where heat is not such a serious problem, needs less material than an adapter extending to the inner surface which means less costs in mass production. However, for higher wattage an adapter extending to the inner surface of the outer envelope is preferred.

Particularly in the case of higher wattages the adapter may have an opening or cavity which surrounds the seal of the burner. In this case the adapter takes up heat which lowers the temperature of the seal. This in turn increases the lifetime of the burner. In this case the lower portion of the burner may be cemented into the adapter to improve the thermal contact.

Experiments have shown that the ceramic is effectively shielding the ballast from the heat. Even in the case that the spatial extension of the shield in a plane perpendicular to the optical axis of the outer envelope is very small, the ceramic was able to decrease the temperature of the ballast by roughly 5° C.

The bottom part of the outer envelope can be made from a plastic or a ceramic as well. It comprises the lamp base with the metallic electric contacts in the form of Edison or bayonet caps. The bottom part and the upper part of the outer envelope may be fastened to each other in a conventional manner.

These and other aspects of the invention will be apparent from and elucidated with reference to the embodiments described thereafter.

### BRIEF DESCRIPTION OF THE DRAWINGS

FIG. 1 shows a principal sketch of the lamp according to the invention,

FIG. 2a shows a photograph of the lamp with the adapter,

FIG. 2b shows a photograph of the lamp with the adapter.

### DETAILED DESCRIPTION OF THE DRAWINGS

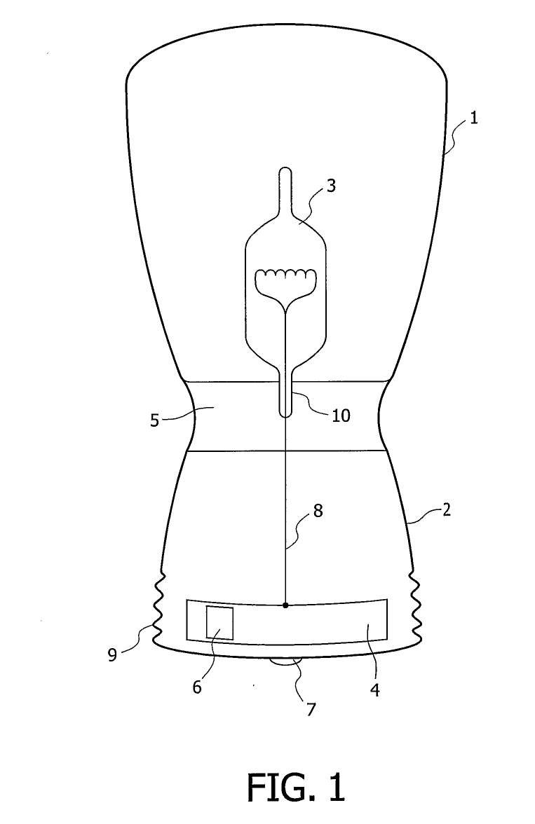

FIG. 1 shows an halogen lamp with an outer envelope having an upper part 1 made of a milky glass. The upper part is transparent for light radiated from the 12 V halogen burner 3. The bottom part 2 is made of plastic and houses the ballast 4 in its interior close to the Edison cap 9. The solid state electronic ballast is incorporated into potting 12 and includes a transformer 6 to transform the mains voltage to a value of 12 V.

The adapter 5 has openings (not shown) which surround the seal of the burner 3. The burner 3 is cemented into the adapter 5 which is made of a ceramic. In this embodiment the adapter 5 is spaced apart from the inner surface of the outer envelope 1, 2 and has electric contacts 7 which are connected to a power supply (not shown).

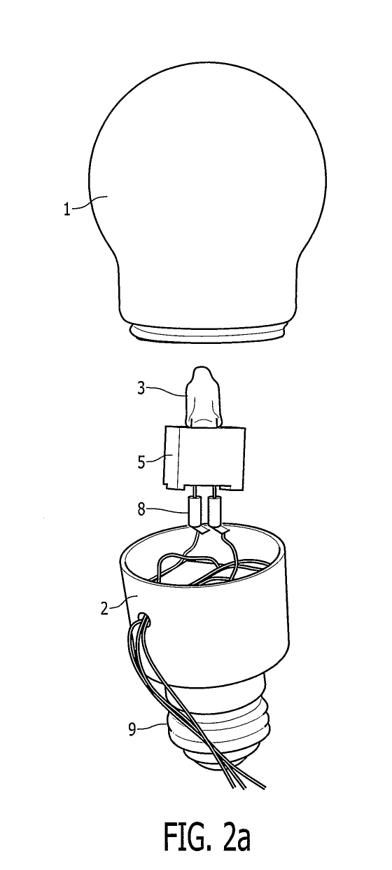

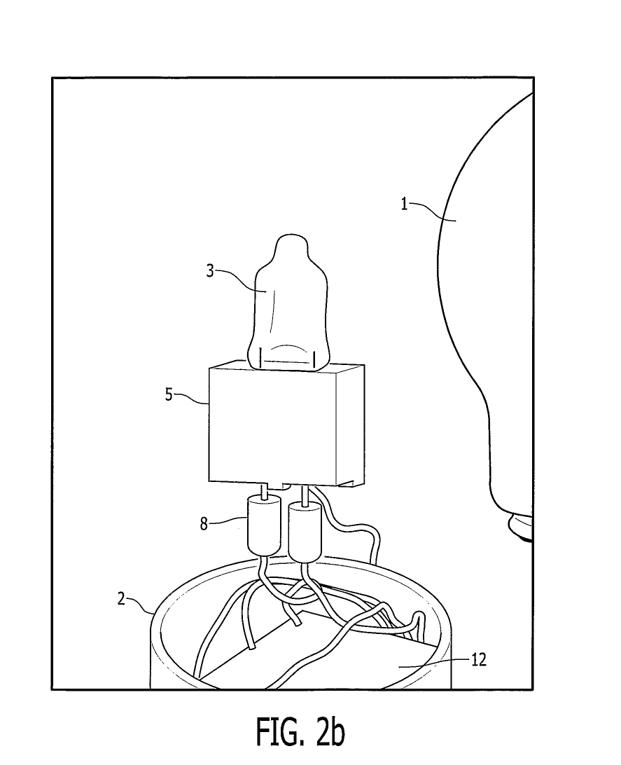

FIG. 2a and FIG. 2b show the case in which the adapter 5 has a cavity to house the seal 10 of the burner 3. This improves the thermal contact between the burner 3 and the adapter 5, which in turn leads to an increased lifetime of burner 3. The upper surface of the adapter 5 has the form of a circular plate extending to the inner surface of the bottom part 2 of the outer envelope. Filament 11 of burner 3 is connected to the ballast 4 by means of the wire 8. Ballast 4 is connected to line voltage by means of Edison cap 9 and contact 7. The ballast 4 includes a transformer 6 to provide the burner 3 with a voltage of 12 V.

1. Halogen lamp, comprising:
a) an outer envelope (1,2) for an incandescent electric lamp, the outer envelope comprising a transparent upper part (1) and a bottom part (2),
b) a low voltage halogen burner (3) arranged within the upper part (1).

2. Halogen lamp according to claim 1, whereby a ballast (4) is arranged within the bottom part (2) of the outer envelope (1,2).

3. Halogen lamp according to claim 1, whereby an adapter (5) is arranged between the ballast (4) and the burner (3).

4. Halogen lamp according to claim 1, whereby the bottom part (2) of the outer envelope (1,2) is made of plastic.

5. Halogen lamp according to claim 1, whereby the upper part (1) is made of a transparent glass.

6. Halogen lamp according to claim 1, whereby the adapter (5) is adapted to fixedly arrange the burner (3).

7. Halogen lamp according to claim 1, whereby the burner (3) has a seal (10) which is surrounded by adapter (5) such that the temperature of the seal is lowered during operation of the lamp.

8. Halogen lamp according to claim 1, whereby the adapter (5) provides electrical contacts for the burner (3).

9. Halogen lamp according to claim 1, whereby the adapter (5) is adapted to shield heat away from the ballast (5).

10. Halogen lamp according to claim 1, whereby the adapter (5) is made of a ceramic.

11. Halogen lamp according to claim 1, whereby the adapter (5) spaced apart from the inner surface of the outer envelope (1, 2).

12. Halogen lamp according to claim 1, whereby the ballast includes a voltage transformer (6) to transform the input voltage of the halogen lamp to a value of 12 V.

13. Process for providing light for ambient lighting including the following steps:
a) generating light in the visible region of the electromagnetic spectrum by means of a low voltage halogen burner (3),
b) transmitting the generated light through an outer envelope for an incandescent electric lamp.
